(19) United States
(12) Patent Application Publication
(10) Pub. No.: US 2002/0111921 A1
(43) Pub. Date: Aug. 15, 2002

(54) Verification method for web-delivered materials

(76) Inventor: Bryan E. Aupperle, Apex, NC (US)

Correspondence Address: Mark D. Simpson, Esquire, Synnestvedt & Lechner, 2600 Aramark Tower, 1101 Market Street, Philadelphia, PA, 19107-2950, US

(21) Appl. No.: 09/781,123

(22) Filed: Feb. 9, 2001

(51) Int. Cl. G06F 17/60; H04L 9/00

(52) U.S. Cl. 705/75; 705/16; 705/64

(57) ABSTRACT

A digital certificate stored on a smart card is used to facilitate the encoding of a key printed as a bar-code (or other readable indicia) on an item to be delivered to the purchaser or the purchaser's designee. When the purchaser or purchaser's designee attempts to receive the item, the smart card must be presented for correlation with the readable indicia associated with the item as a result of the purchase. The same digital certificate from the smart card must be used to validate the encrypted information associated with the item, so that only the person holding the smart card used at the time of purchase can obtain the item. In a preferred embodiment, the present invention is used in connection with the purchase of tickets redeemable for an event.

### BACKGROUND OF THE INVENTION

1. Field of the Invention

The present invention relates to a method and system for verification of electronic purchases; more particularly, in a preferred embodiment, the present invention relates to a method and system for verifying that the person in possession of electronically-delivered tickets actually purchased them.

2. Description of the Related Art

The merger of the Internet and commerce to form what is now known worldwide as “E-Commerce” has led to the proliferation of the use of the Internet and World Wide Web (“the Web”) for purchases of all kinds. Everything from airline tickets to automobiles to vitamins can be purchased on the Web and such sales have experienced explosive growth. Such purchases are referred to herein as Electronically-Purchased Items (EPI's).

The area of electronic ticketing presents unique security issues not found with conventional “product-based” E-commerce, particularly when the tickets are delivered to the purchaser electronically and printed at the customer's site. As an example, consider the sale of tickets to sporting and/or concert events over the Internet. For a company to electronically distribute admission tickets for such events, the customers must be able to print the tickets on their local printer. Both the actual purchaser and the event promoter have an interest in being able to ensure that only the person who purchased the ticket is able to use it to attend the event. The problem, however, is that tickets printed in this manner are easily copied or able to be printed multiple times, thereby limiting the ability of the actual purchaser and event promoter to assure that only the actual purchaser is given access to the event.

A company called “AdmissionControl.com” has introduced a system whereby electronic tickets are ordered and the purchase completed online by individuals who have pre-registered with the company using a credit card or debit card. The system of AdmissionControl.com does not involve the printing of a ticket; instead, AdmissionControl.com devices are located at the venue where the event is to occur. When attending an event, the purchaser brings the credit or debit card used to make the purchase and inserts the card into the AdmissionControl.com device. The device reads the identifying information off of the credit card or debit card and correlates this data, via a connection to an AdmissionControl.com database, with a valid purchase made through the AdmissionControl.com system. The device then sends an instruction to open barrier doors (e.g., release the lock on a turnstile) and to print a receipt with seating assignments for the appropriate number of validated admissions. Thus, the user must only bring the card used to make the purchase with them to gain entry into the event.

The AdmissionControl.com system, however, requires that the financial information related to the user's credit card (e.g., credit card number; expiration date; billing address) be stored on the AdmissionControl.com ticketing system, and that it can either be stored at or transmitted to and from the event site. Data theft is an increasing problem with E-commerce and by allowing AdmissionControl.com to store and transmit valuable and confidential customer data, users may be reluctant to use the AdmissionControl.com system; use of the AdmissionControl.com system may subject this information to data theft. In addition, having the customer data available at multiple event sites increases the number of possible intrusion points and thus reduces the security of the information.

A technology known as Information Based Indicia (IBI) has been developed as a means for verifying the validity of a paper-based item bearing the IBI. The United States Postal Service is working on a project with third parties called the Information Based Indicia Program (IBIP). Information about IBIP can be found on the U.S. Postal Service web site at http://www.usps.gov/IBIP. When used in connection with the U.S. Postal Service Project, the IBI is printed on an envelope and conveys evidence that the postage has been paid and contains mail processing data requirements as well as security-related data elements. The indicia is made up of human-readable information as well as a two-dimensional bar code with the following information: zip code; destination delivery point, software ID, ascending register; descending register; algorithm ID; device ID; date of mailing; postage; digital signature; rate category; reserve field; indicia version number; and certificate serial number.

Using the IBI printed on the paper document, such as the envelope in the postal service example, a bar code reader can look for particular information and verify that the bar code has identified a valid transaction. However, nothing prevents someone from printing or copying the information-based indicia and utilizing it on fraudulent paper documents or using it in a fraudulent manner with other paper documents. Thus, if used with the sale of event tickets, there is nothing to stop a user from purchasing one ticket and then printing multiple copies and/or prevent someone from fraudulently obtaining an authorized event ticket and photocopying it for use.

In addition to the above-described security risks, the AdmissionControl.com system requires that printers, loaded with paper and toner, be maintained at all event sites so that the receipts and seating assignments can be printed out.

### SUMMARY OF THE INVENTION

In accordance with a preferred embodiment of the present invention, a two-step process is used to purchase and redeem an EPI, for example, a ticket. In the first step of the process, referred to herein as the “purchasing step,” a digital certificate stored on a smart card is used to facilitate the encoding of a key printed as a readable indicia (e.g., a bar code) on a ticket prior to its printing. Credit card information or other purchasing information is transmitted and verified (but not stored) as part of this first step.

In the second step of the process, referred to herein as the “validation step,” when the purchaser completes the transaction, for example, attends the event for which the ticket is issued, the ticket is presented by the purchaser for validation. The same digital certificate from the smart card must be used to validate the encrypted information on the printed ticket before entry into the event, so that only the person holding the smart card used for the purchasing step can use the printed ticket for admission to the event. Once validated, the purchase is considered complete.

In accordance with a first embodiment, the present invention comprises a method of correlating a purchaser of an electronically-purchased item (“EPI”) with the EPI, the EPI to be subsequently received by the purchaser or the purchaser's designee, comprising: a purchasing step, wherein purchaser-related financial and digital certificate information is transferred to a seller of the EPI; and a verification step, wherein the purchaser and the EPI are correlated by requiring the purchaser or the purchasers designee to provide the purchaser-related digital certificate information before receiving the EPI and by electronically comparing the purchaser-related digital certificate information with the EPI.

In a preferred embodiment, the purchasing step includes at least the steps of: creating an electronically-readable indicia corresponding to the digital certificate information of the purchaser; and associating the electronically-readable indicia with the EPI.

In a most preferred embodiment, the EPI comprises tickets or other redeemable documents, the electronically-readable indicia comprises bar-coding markings on the EPI, and the purchaser-related digital certificate information is provided via a smart card.

### BRIEF DESCRIPTION OF THE DRAWINGS

FIG. 1 illustrates an example of a system which can be used in the practice of the present invention;

FIG. 2 is a flowchart illustrating the steps performed in accordance with a first embodiment of the present invention; and

FIG. 3 illustrates an alternative embodiment of the present invention wherein the printing of a ticket purchased using the inventive method is delayed until a time after the purchase transaction.

### DETAILED DESCRIPTION OF THE PREFERRED EMBODIMENTS

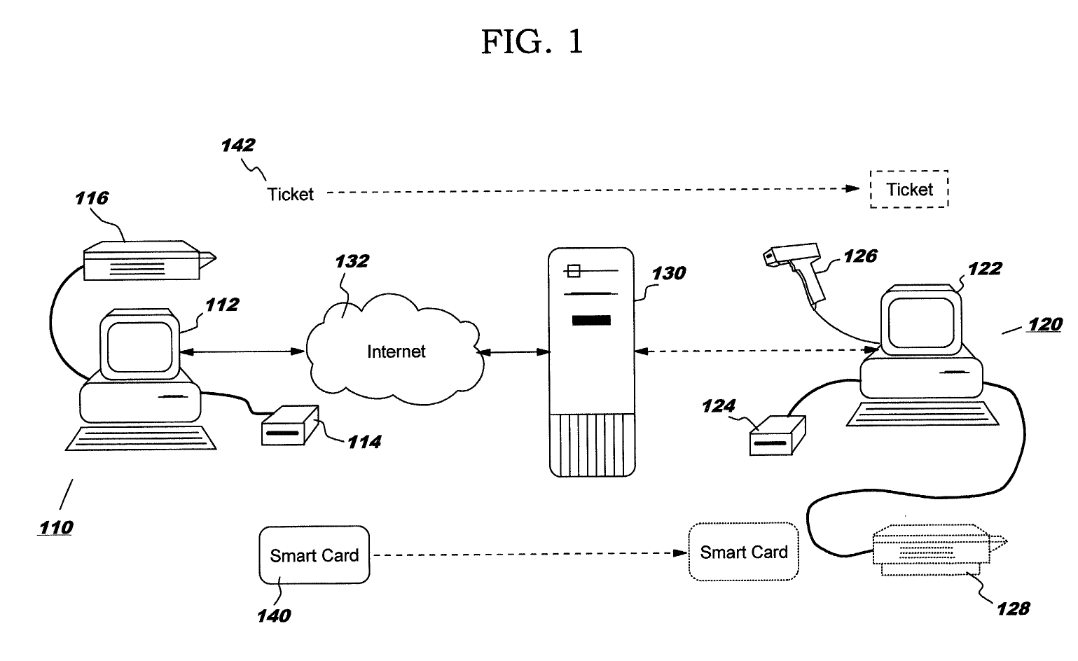

FIG. 1 illustrates an example of a system which can be used to practice the present invention. Referring to FIG. 1, a ticketing device 110 comprising, for example, a PC 112, smart card reader 114 and printer 116 is connected to a ticket server 130 via any known means, for example, the Internet 132. Typically, the ticketing device 110 would be located at a consumer's location and the ticket server 130 would be located at a ticket seller's location. A ticket validation device 120 is located at the venue where a ticket purchased by a consumer is to be used. The ticket validation device 120 comprises, for example, a PC 122, a smart card reader 124, and a coded-information reader 126, for example, a bar-code reader. A Point-of-Sale (POS) terminal commonly found at grocery stores is one example of such a device. In an alternative embodiment, the ticket validation device 120 is connectable to ticket server 130 via any known means, such as a direct network connection or via the Internet. Further, in this alternative embodiment, a printer 128 is also connectable to ticket validation device 120.

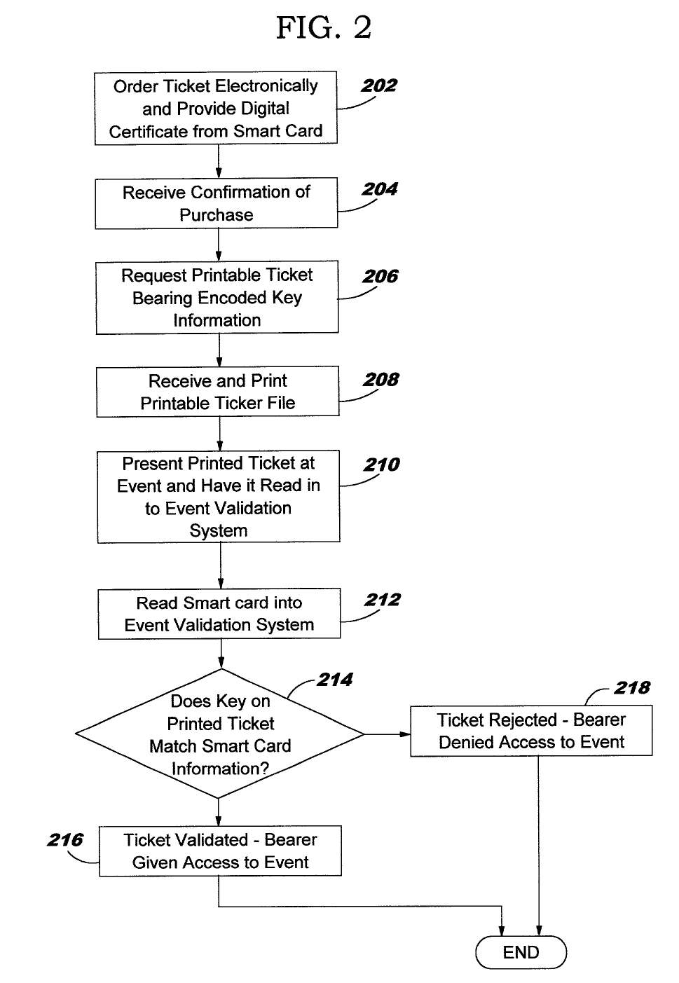

The operation of the invention in accordance with a first embodiment is illustrated now with reference to FIGS. 1 and 2. FIG. 2 is a flowchart illustrating the steps performed in accordance with the first embodiment.

At step 202, a ticket is electronically ordered using ticket device 110. Typically, this would involve a consumer establishing a connection between ticket device 110 and ticket server 130 via the Internet. The consumer accesses a website of the ticket seller and makes a ticket selection in a well known, conventional manner, e.g., by “clicking” on a listed event and a specific date, and then providing billing information, such as a credit card number and expiration date of the credit card.

As part of the ticket ordering process, in accordance with the present invention, the consumer also “reads in” a smart card 140 via smart card reader 114. Smart cards are well known and typically comprise a plastic card approximately the size of a standard credit card. They typically include a computer chip enabling the card to store and/or process information and often include a “digital certificate,” a password protected, encrypted data file which includes name information and other data which serves to identify the owner of the smart card. The digital certificate also includes a public key which serves to verify the “digital signature” (a matching key) of the smart card owner in a known manner.

Digital certificate information identifying the owner of the smart card and any other desired parameters relating to the purchaser (e.g., name; address; date of birth, etc.) are transmitted to the ticket server 130. At step 204, a confirmation message is sent from the ticket server 130 and received by the consumer at ticket device 110. The confirmation message transmitted from the ticket server includes additional information identifying the EPI correlated with the digital certificate information transmitted to the ticket server at step 202. This EPI information could include, in the context of ticket sales, the date of the event, the performer at the event, seating information, ticket price, etc. Upon receipt of the ticket confirmation message, the consumer sends to the ticket server, via automatic or manual input to the ticket device transmitted over the Internet, a request for a printable ticket bearing encoded key information (step 206).

The ticket server 130 receives this request and returns a file to the ticket device 110 consumer comprising printable ticket and encoded key information corresponding to the digital certificate information received from the smart card and the confirmation message supplied by the ticket server (step 208).

When the consumer prints the printable ticket, he/she receives a printed ticket bearing the machine-readable encoded key information (e.g., in bar code format). Completion of this step completes the purchasing step of the two-step process of the present invention.

The validation step of the process typically will take place at the event location. At step 210, the consumer takes the printed ticket and the smart card used to make the purchase to the venue where the event is to take place and presents the printed ticket 142 to the ticket validation device 120. The encoded key information is read by the ticket validation device 120, and the user is requested to input the smart card to the device 120. At step 212, the smart card information is read into the validation system. At step 214, a determination is made as to whether or not the key on the printed ticket matches or otherwise validates the smart card information provided.

If the key information on the ticket corresponds to the smart card information, at step 216 the ticket is validated and the bearer is given access to the event. The validation can come in several forms, including a printed validation ticket; alternatively, the validation process can unlock a turnstile or other barrier device to allow access. To avoid multiple validation of identical tickets using the same smart card, if desired the validation process can include the implementation of a “record lock” so that a proper validation can occur only once. This can be implemented in a variety of known ways, for example, through the use of software flags that are set once a proper validation has occurred. Alternatively, or in addition to, the use of record locks, a biometric validation system (e.g., thumbprint scan or eye scan) can be used to link the card holder to the card owner and block validation if the biometric validation fails.

If the key on the printed ticket does not correspond to the smart card information, at step 218 the ticket is rejected and the bearer is denied access to the event. If desired, a signal or other indication means can automatically alert event staff or other authorities that an unauthorized access is being attempted.

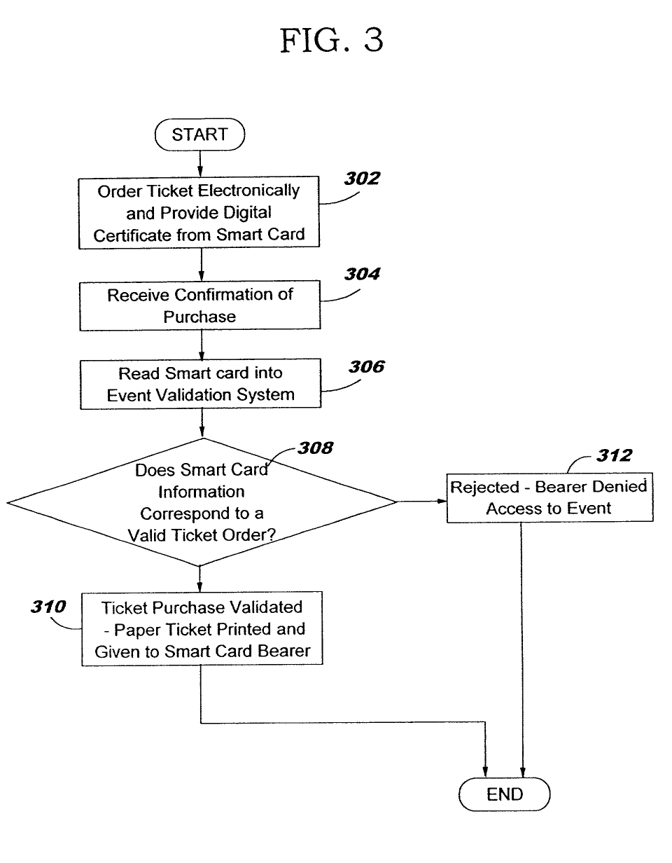

FIG. 3 illustrates an alternative embodiment in which the printing of the ticket is delayed until later requested by the purchaser. In the example shown in FIG. 3, the printing is delayed until the purchaser arrives at the event venue. Steps 302, 304, and 306 correspond to steps 202, 204, and 212, respectively, of FIG. 2 and the operation thereof is identical to that described above. However, once the smart card is read into the event validation system at the event venue, at step 308 the ticket verification device communicates with the ticket server to determine if the smart card information corresponds to a valid ticket order for the event. If a valid ticket purchase for the event is confirmed, at step 310 a paper ticket is printed and given to the smart card bearer, which ticket is then surrendered upon entry into the venue. Further attempts to validate the same “ticket” will be rejected as described above.

If, at step 308, a determination is made that the smart card information does not correspond to a valid ticket order, at step 312, the bearer of the smart card is rejected access to the event. Again, as described above, if desired, a signal or other indication means can automatically alert event staff or other authorities that an unauthorized access is being attempted.

While the above “delayed printing” alternative described above with respect to FIG. 3 illustrates the printing of the ticket at the event site, it is not intended for the present invention to be so limited. For example, the ability to delay printing is also useful in situations where the purchaser orders tickets from a remote location, e.g., via a cell phone or PDA. The user could input the smart card information at the time the print request is made; alternatively, digital certificate information identical to that stored on the smart card could be stored on the cell phone or PDA and supplied to the purchasing system at the time the order is placed. This method allows a remote purchaser to purchase/order tickets and print them at a later, convenient time when access to a printer is available. Like the above examples, the printed ticket will still have to be presented with a smart card (or other personal storage device) bearing the digital certificate information so that the ticket could be validated.

If multiple tickets are ordered and all ticket-holders cannot enter the venue with the purchasing party (e.g., in the case where one or more of the ticket holders wants to arrive earlier or later than the purchasing party) then when the tickets are printed, an option can be made available to allow the purchasing party to first enter his/her smart card information, followed by entry of the smart card information of the person or persons who will be the actual ticket holders, so that the ticket holder(s) will then be able to validate the ticket with his/her smart card. This makes the purchase effectively transferable.

Using the present invention, there is no need to go to a “will-call” window to pick up tickets or to have them delivered at an additional delivery charge. Further, in contrast to prior art systems, there is no need to store and access the purchaser's confidential credit card information, thereby removing the data security risks associated therewith. All financial information related to the purchase is completed during the purchasing step, and no financial information is stored by the system or utilized for the verification process. In addition, since users will frequently be printing the tickets at a location other than the event site, and since all of the validation information is carried by the ticket holder on the smart card, the amount of data required to be stored at the event location (or accessed by the ticket validation devices at the event location) is minimized.

Although the present invention has been described with respect to a specific preferred embodiment thereof, various changes and modifications may be suggested to one skilled in the art. For example, the present invention can be utilized in the purchase and sale of non-redeemable items, e.g. bicycles, toys, books, consumer products, etc. by, for example, transmitting the digital certificate information over the Internet to the seller of the goods at the time of purchase. On the seller end, a label or a verification document bearing the bar-coded digital certificate information could be printed and associated with the purchased item. When the purchaser comes to a store location to pick up the purchased item, the seller can require verification by scanning the bar code and scanning in the smart card before releasing the goods to the purchaser. This would speed up the pick-up and minimize the time spent in the store. It is thus intended that the present invention encompass such changes and modifications as fall within the scope of the appended claims.

We claim:

1. A method of correlating a purchaser of an electronically-purchased item (“EPI”) with the EPI, said EPI to be subsequently received by said purchaser, comprising:
a purchasing step, wherein purchaser-related financial and digital certificate information is transferred to a seller of said EPI and verification-related digital certificate information is transferred to said purchaser; and
a verification step, wherein said purchaser and said EPI are correlated by requiring said purchaser to provide said verification-related digital certificate information before receiving said EPI and by electronically comparing said verification-related digital certificate information with said EPI.

2. The method as set forth in claim 1, wherein said purchasing step includes at least the steps of:
creating an electronically-readable indicia corresponding to said verification-related digital certificate information; and
associating said electronically-readable indicia with said EPI.

3. The method as set forth in claim 2, wherein said verification step comprises:
electronically reading said verification-related digital certificate information from said electronically-readable indicia into a verification system prior to receiving said EPI; and
comparing said read verification-related digital certificate information with verification-related digital certificate information provided by a person attempting to receive the EPI.

4. The method as set forth in claim 3, wherein the EPI is authorized to be released to said person attempting to receive the EPI only after the EPI is confirmed to have associated therewith verification-related digital certificate information corresponding to the verification-related digital certificate information provided by said receiving party.

5. The method as set forth in claim 4, wherein said verification-related digital certificate information comprises an encrypted data file containing personal data pertaining to said purchaser.

6. The method as set forth in claim 4, wherein said verification-related digital certificate information comprises a data file containing encrypted data pertaining to said EPI.

7. The method as set forth in claim 4, wherein said digital certificate information comprises an encrypted data file containing personal data pertaining to said purchaser and data pertaining to said EPI.

8. The method as set forth in claim 4, wherein said purchaser-related digital certificate information is provided by data stored on a smart card.

9. The method as set forth in claim 4, wherein said purchaser-related digital certificate information is supplied from data stored on a PDA.

10. The method as set forth in claim 4, wherein said purchaser-related information is supplied from data stored on a cellular telephone.

11. The method as set forth in claim 2, wherein said electronically-readable indicia comprises bar coding.

12. A method of correlating a purchased item to be picked up by a purchaser with the purchaser of the item, comprising the steps of:
transferring indicia of verification-related digital certificate information to the purchased item;
requiring said purchaser to present said verification-related digital certificate information upon picking up said item; and
correlating said purchased item with the purchaser of the item by electronically comparing said verification-related digital certificate information presented by said purchaser with said indicia.

13. A method of correlating a purchased redeemable ticket (PRD) with the purchaser of the redeemable ticket, comprising:
a purchasing step, wherein purchaser-related financial and digital certificate information is transferred to a seller of said PRD and verification-related digital certificate information is transferred to said purchaser; and
a verification step, wherein said purchaser and said PRD are correlated by requiring said purchaser to provide said verification-related digital certificate information before receiving said PRD and by electronically comparing said verification-related digital certificate information with said PRD.

14. The method as set forth in claim 13, wherein said purchasing step includes at least the steps of:
creating an electronically-readable indicia corresponding to said verification-related digital certificate information; and
associating said electronically-readable indicia with said PRD.

15. The method as set forth in claim 14, wherein said verification step comprises:
electronically reading said verification-related digital certificate information from said electronically-readable indicia into a verification system prior to receiving said PRD; and
comparing said read verification-related digital certificate information with verification-related digital certificate information provided by a person attempting to receive the PRD.

16. The method as set forth in claim 15, wherein the PRD is authorized to be released to said person attempting to receive the PRD only after the PRD is confirmed to have associated therewith verification-related digital certificate information corresponding to the verification-related digital certificate information provided by said receiving party.

17. The method as set forth in claim 16, wherein said verification-related digital certificate information comprises an encrypted data file containing personal data pertaining to said purchaser.

18. The method as set forth in claim 16, wherein said verification-related digital certificate information comprises a data file containing encrypted data pertaining to said PRD.

19. The method as set forth in claim 16, wherein said digital certificate information comprises an encrypted data file containing personal data pertaining to said purchaser and data pertaining to said PRD.

20. The method as set forth in claim 16, wherein said purchaser-related digital certificate information is provided by data stored on a smart card.

21. The method as set forth in claim 16, wherein said purchaser-related digital certificate information is supplied from data stored on a PDA.

22. The method as set forth in claim 16, wherein said purchaser-related information is supplied from data stored on a cellular telephone.

23. The method as set forth in claim 13, wherein said electronically-readable indicia comprises bar coding.
